(19) United States
(12) Patent Application Publication
(10) Pub. No.: US 2024/0070578 A1
(43) Pub. Date: Feb. 29, 2024

(54) ENGINEERING FACILITY SCHEDULING METHOD AND SYSTEM, AND ENGINEERING FACILITY

(71) Applicant: SHANGHAI HUAXING DIGITAL TECHNOLOGY CO LTD, Shanghai (CN)

(72) Inventors: Minjian ZHU, Shanghai (CN); Changming WU, Shanghai (CN); Xudong GUO, Shanghai (CN)

(21) Appl. No.: 18/272,443

(22) PCT Filed: Jun. 7, 2022
(86) PCT No.: PCT/CN2022/097448

§ 371 Date: Jul. 14, 2023

(30) Foreign Application Priority Data
Jun. 28, 2021 (CN) 202110722624.4

(51) Int. Cl. G06Q 10/0631; G06Q 50/04; G06Q 50/28

(52) U.S. Cl. CPC G06Q 10/06312; G06Q 50/04; G06Q 50/28; G06Q 10/063116; G06Q 50/02

(57) ABSTRACT

An engineering facility scheduling method provided by the present application includes: obtaining facility information and working condition information of an engineering facility; obtaining, based on the facility information, a scheduling group where the engineering facility is located, and obtaining a scheduling policy corresponding to the scheduling group; generating, based on the scheduling policy and the working condition information of the engineering facility, a scheduling instruction for instructing the engineering facility to perform work; and sending the scheduling instruction to the engineering facility. According to the engineering facility scheduling method of the present application, the scheduling instruction can be generated according to the specific scheduling policy and working condition information, thereby increasing the degree of automation of engineering facility scheduling and improving engineering facility scheduling efficiency.

### TECHNICAL FIELD

The present application relates to the technical field of industry and mining, in particular to an engineering facility scheduling method and system, and an engineering facility.

### BACKGROUND

With the rapid development of economy, urban construction, highway construction, mining and other aspects are also in rapid development, which also leads to the constant growth of labor costs. How to reduce business costs and carry out fine management on engineering facilities involved in mines, earthwork, construction sites, etc. has been a problem for the majority of business owners. At present, in the management process of engineering facilities for mines, it is necessary to manually make instructions with detailed time and clear scheduling information for operators and facilities, and the engineering facilities perform the work corresponding the instructions according to the instructions. Therefore, the shift arrangement and scheduling management of the engineering facilities needs a large number of manual participation, which may increase labor costs and reduce the efficiency of the planning of shift arrangement. How to reduce manual participation and make the management of mine engineering facilities more automatic is a technical problem that needs to be solved.

### SUMMARY

In view of this, the present application provides an engineering facility scheduling method and system, and an engineering facility, which solve the problem that the shift arrangement and scheduling management of engineering facilities requires a large number of manual participation at present.

In a first aspect, the present application provides an engineering facility scheduling method. The method includes: obtaining facility information and working condition information of an engineering facility; obtaining, based on the facility information, a scheduling group where the engineering facility is located, and obtaining a scheduling policy corresponding to the scheduling group; generating, based on the scheduling policy and the working condition information of the engineering facility, a scheduling instruction for instructing the engineering facility to perform work; and sending the scheduling instruction to the engineering facility.

In the implementation of the present application, the facility information may include load data, facility type, latitude and longitude and historical working data of the engineering facility, and the scheduling group where the engineering facility is located. The working condition information may include idle status information, waiting time information, no-load status information, and full-load status information of the engineering facility, information of a distance of the engineering facility from other engineering facilities, and other information of the engineering facility. Moreover, the working condition information may be updated in real time. After the engineering facility performs certain work, the working condition information obtained is the latest working condition information corresponding to real-time data after the engineering facility performs the work. During grouping, a plurality of engineering facilities that may cooperate with each other to complete a whole set of industrial and mining work may form one scheduling group. A shift arrangement plan may be shift time used for instructing the scheduling group to perform work, and the engineering facilities in the scheduling group perform work according to the shift time specified in the shift arrangement plan. The scheduling policy is a rule to be followed when the scheduling group is instructed to perform work. Under different scheduling policies, different scheduling instructions may be correspondingly issued to each engineering facility in the scheduling group. The scheduling group where the engineering facility is located is obtained from the facility information, and then the scheduling policy of the scheduling group is obtained. Different combinations of different scheduling policies and different working condition information may correspond to different scheduling instructions. When an engineering facility needs to be scheduled, on the basis that different scheduling policies may correspond to different scheduling instructions, and combined with the working condition information of the engineering facility, the scheduling instruction is generated based on the actual working condition information. Moreover, in the process of obtaining the scheduling instruction, the working condition information referred to is the working condition information updated in real time. Finally, the scheduling instruction is sent to the engineering facility for the engineering facility to perform the corresponding work according to the scheduling instruction.

In combination with the first aspect, in one possible implementation, the scheduling group where the engineering facility is located is determined by the following steps: determining, based on the obtained facility information of the engineering facility, a matching degree of facility information of different engineering facilities; and classifying, based on the matching degree of the facility information of the different engineering facilities, a plurality of the engineering facilities into one scheduling group.

In combination with the first aspect, in one possible implementation, the engineering facility includes: an excavating and loading facility and a transportation facility. The obtaining facility information of the engineering facility includes: obtaining a historical total loading duration of the excavating and loading facility, a historical average round-trip duration of the transportation facility, and a historical average loading duration of the transportation facility. The classifying, based on the matching degree of the facility information of the different engineering facilities, the plurality of the engineering facilities into one scheduling group includes: obtaining a matching degree between the excavating and loading facility and the transportation facility by dividing the historical total loading duration by a sum of the historical average round-trip duration and the historical average loading duration; classifying, if the matching degree is greater than or equal to a preset threshold, the corresponding excavating and loading facility and transportation facility into the same scheduling group; and performing rematching and grouping if the matching degree is less than the preset threshold.

In combination with the first aspect, in one possible implementation, the scheduling policy includes sequential scheduling and unmanned scheduling; and the generating, based on the scheduling policy and the working condition information of the engineering facility, a scheduling instruction for instructing the engineering facility to perform work includes: generating a sequential scheduling instruction for instructing the transportation facility to move to the excavating and loading facility in turn to perform loading work and then move to an unloading platform specified by the scheduling group to perform unloading, if the scheduling group where the transportation facility is located is the sequential scheduling or the unmanned scheduling and working condition information of the transportation facility is a no-load status.

In combination with the first aspect, in one possible implementation, the scheduling policy further includes automatic scheduling; and the generating, based on the scheduling policy and the working condition information of the engineering facility, the scheduling instruction for instructing the engineering facility to perform work further includes: searching for an excavating and loading facility with working condition information being a shortest idle time and generating a priority loading scheduling instruction for instructing the transportation facility in the no-load status to move to the excavating and loading facility with the shortest idle time to perform loading work if the scheduling group where the transportation facility is located is the automatic scheduling, the working condition information of the transportation facility is the no-load status, and the working condition information of the transportation facility is non-wait timeout.

In combination with the first aspect, in one possible implementation, the scheduling policy further includes automatic scheduling; and the generating, based on the scheduling policy and the working condition information of the engineering facility, the scheduling instruction for instructing the engineering facility to perform work further includes: regenerating a scheduling instruction if the scheduling group where the transportation facility is located is the automatic scheduling, the working condition information of the transportation facility is the no-load status, and the working condition information of the transportation facility is wait timeout.

In combination with the first aspect, in one possible implementation, the generating, based on the scheduling policy and the working condition information of the engineering facility, the scheduling instruction for instructing the engineering facility to perform work further includes: generating, if the scheduling group where the transportation facility is located is the sequential scheduling, the automatic scheduling or the unmanned scheduling and the working condition information of the transportation facility is a full-load status, a full-load scheduling instruction for instructing the transportation facility in the full-load status to move to an unloading platform specified by the scheduling group to perform unloading work.

In combination with the first aspect, in one possible implementation, the generating, based on the scheduling policy and the working condition information of the engineering facility, the scheduling instruction for instructing the engineering facility to perform work further includes: generating, if the scheduling group where the transportation facility is located is the unmanned scheduling, and the working condition information of the transportation facility is that a distance from a transportation facility ahead is less than a safety distance, a deceleration scheduling instruction for instructing the transportation facility having the distance from the transportation facility ahead being less than the safety distance to decelerate.

In a second aspect, the present application provides an engineering facility scheduling system. The system includes: an operation management module configured to: record facility information and working condition information of an engineering facility and form one scheduling group by a plurality of engineering facilities; a shift arrangement and scheduling module electrically connected with the operation management module and configured to: make a shift arrangement plan and a scheduling policy of the scheduling group; an instruction generation module electrically connected with the shift arrangement and scheduling module and configured to: obtain the facility information and the working condition information of the engineering facility, obtain, based on the facility information, the scheduling group where the engineering facility is located, obtain the scheduling policy corresponding to the scheduling group, and generate, based on the scheduling policy and the working condition information of the engineering facility, a scheduling instruction for instructing the engineering facility to perform work; and an instruction sending module electrically connected with the instruction generation module and configured to: send the scheduling instruction to the engineering facility.

In a third aspect, the present application provides an engineering facility. The engineering facility includes: a facility intelligent terminal configured to: obtain the scheduling instruction according to any one of the above implementations; switch the engineering facility to an online status and instruct the engineering facility to perform work corresponding to the scheduling instruction, if it is identified that the engineering facility has the working condition information within a preset period of time; and switch the engineering facility to a rest status or an offline status and instruct the engineering facility not to perform work, if it is identified that the engineering facility has no working condition information within a preset period of time.

In a fourth aspect, the present application provides an electronic device. The electronic device includes a memory, a processor, and a computer program that is stored on the memory and capable of running on the processor, the processor performing steps of the engineering facility scheduling method according to any one of the above implementations.

In a fifth aspect, the present application provides a computer-readable storage medium having a computer program stored on computer-readable storage medium, the computer program being configured to perform steps of the engineering facility scheduling method according to any one of the above implementations.

During use of the engineering facility scheduling method and system according to the present application, the scheduling policy of the scheduling group is made firstly, when an engineering facility needs to be scheduled, work is performed at the corresponding shift time according to the shift arrangement plan of the scheduling group, and the scheduling instruction is generated in combination with the scheduling policy and the working condition information and then sent to the engineering facility, such that complete and reliable engineering facility scheduling may be achieved. Throughout the whole process, manual participation is reduced, and the scheduling instruction may be generated according to the specific scheduling policy and working condition information, thereby increasing the degree of automation of engineering facility scheduling and improving engineering facility scheduling efficiency.

### BRIEF DESCRIPTION OF DRAWINGS

The above and other objects, features, and advantages of the present application will become more apparent by describing embodiments of the present application in more detail with reference to the accompanying drawings. The accompanying drawings, which are intended to provide a further understanding of the embodiments of the present application and constitute a part of the specification, serve to explain the present application together with the embodiments of the present application, and do not constitute a limitation on the present application. In the figures, the same reference numeral typically represents the same part or step.

FIG. 1 shows a schematic diagram of steps of an engineering facility scheduling method provided by an embodiment of the present application.

FIG. 2 shows a schematic diagram of steps of an engineering facility scheduling method provided by another embodiment of the present application.

FIG. 3 shows a schematic diagram of steps of an engineering facility scheduling method provided by yet another embodiment of the present application.

FIG. 4 shows a schematic diagram of steps of an engineering facility scheduling method provided by yet another embodiment of the present application.

FIG. 5 shows a schematic diagram of steps of an engineering facility scheduling method provided by yet another embodiment of the present application.

FIG. 6 shows a schematic structural diagram of an engineering facility scheduling system provided by an embodiment of the present application.

FIG. 7 shows a schematic scheduling flowchart of an engineering facility scheduling method and system provided by an embodiment of the present application.

FIG. 8 shows a schematic structural diagram of an electronic device provided by an embodiment of the present application.

### DETAILED DESCRIPTION OF EMBODIMENTS

The technical solutions of the embodiments of the present application will be clearly and completely described below with reference to the accompanying drawings of the embodiments of the present application. Apparently, the embodiments described hereinafter are merely a part of the embodiments of the present application, rather than all of the embodiments. Based on the embodiments of the present application, all other embodiments obtained by a person of ordinary skill in the art without any creative effort fall within the protection scope of the present application.

The present application provides an engineering facility scheduling method for use in mines. In one embodiment, the engineering facility scheduling method may be performed by a processor with computing and processing capabilities, and the processor may be mounted in a mine control room. FIG. 1 shows a schematic diagram of steps of an engineering facility scheduling method according to an embodiment of the present application. In some embodiments, as shown in FIG. 1, the engineering facility scheduling method includes the following steps.

Step 110: Obtain facility information and working condition information of an engineering facility.

Specifically, the facility information in this step may include load data, facility type, latitude and longitude and historical working data of the engineering facility and a scheduling group where the engineering facility is located. A specific location where the engineering facility is located may be known based on the latitude and longitude. The engineering facility may be better scheduled based on the latitude and longitude. The working condition information may include idle status information, waiting time information, no-load status information, and full-load status information of the engineering facility, information of a distance of the engineering facility from other engineering facilities, and other information of the engineering facility. Moreover, the working condition information may be updated in real time. After the engineering facility performs certain work, the working condition information obtained is the latest working condition information corresponding to real-time data after the engineering facility performs the work.

Step 120: Obtain, based on the facility information, the scheduling group where the engineering facility is located, and obtain a scheduling policy corresponding to the scheduling group.

During performing of this step, when an engineering facility needs to be scheduled, the facility information of the engineering facility is firstly obtained and processed, the scheduling group where the engineering facility is located is obtained based on the facility information, and then the scheduling policy of the scheduling group is obtained. The scheduling policy may be made manually in advance for the scheduling group, or may be made automatically by a trained artificial intelligence model for the scheduling group. The scheduling policy is a basic rule to be followed when the scheduling group is instructed to perform work. Under different scheduling policies, different scheduling instructions may be correspondingly issued to each engineering facility in the scheduling group.

Step 130: Generate, based on the scheduling policy and the working condition information of the engineering facility, a scheduling instruction for instructing the engineering facility to perform work.

Specifically, different combinations of different scheduling policies and different working condition information may correspond to different scheduling instructions. During performing of this step, when an engineering facility needs to be scheduled, on the basis that different scheduling policies may correspond to different scheduling instructions, and combined with the working condition information of the engineering facility, the scheduling instruction is generated based on the actual working condition information. Moreover, in the process of obtaining the scheduling instruction, the working condition information referred to is the working condition information updated in real time.

Step 140: Send the scheduling instruction to the engineering facility.

During performing of this step, the scheduling instruction is sent to the engineering facility for the engineering facility to perform the corresponding work according to the scheduling instruction.

During use of the engineering facility scheduling method according to this embodiment, a shift arrangement plan and the scheduling policy of the scheduling group may be made firstly. The shift arrangement plan may be shift time used for instructing the scheduling group to perform work, and the engineering facility in the scheduling group performs work according to the shift time specified in the shift arrangement plan. The scheduling policy is a rule to be followed when the scheduling group is instructed to perform work. Under different scheduling policies, different scheduling instructions may be correspondingly issued to each engineering facility in the scheduling group. The shift arrangement plan may be modified in real time, and the scheduling group may perform work based on the new shift arrangement plan subsequently.

When an engineering facility needs to be scheduled, work is performed at the corresponding shift time according to the shift arrangement plan of the scheduling group, and the scheduling instruction is generated in combination with the scheduling policy and the working condition information and then sent to the engineering facility, such that complete and reliable engineering facility scheduling may be achieved. Throughout the whole process, manual participation is reduced, and the scheduling instruction may be generated according to the specific scheduling policy and working condition information, thereby increasing the degree of automation of engineering facility scheduling and improving engineering facility scheduling efficiency. During the whole scheduling work, the quantity of dispatchers and management personnel is reduced through an automatic identification logic, thereby reducing the labor cost. Moreover, the fragmentation time of the facility may be shortened, thereby making each stage of production tasks more compact and improving the overall working efficiency of the facility.

In some specific embodiments, the composition of the engineering facilities in the scheduling group may be modified in real time during the operation of the engineering facilities, and the modification takes effect immediately, once modified. A new scheduling instruction may be generated subsequently according to a new scheduling group without manual intervention by a driver, and the driver of the engineering facility only needs to perform work according to the new scheduling instruction.

In some specific embodiments, after an engineering facility is powered up, facility information and working condition information of the newly powered up engineering facility may be obtained, and a scheduling instruction corresponding to the working condition information may be issued to the engineering facility according to the shift arrangement plan and the scheduling policy of the scheduling group where the engineering facility is located, which means that scheduling of the engineering facility has already started as soon as the engineering facility is powered up.

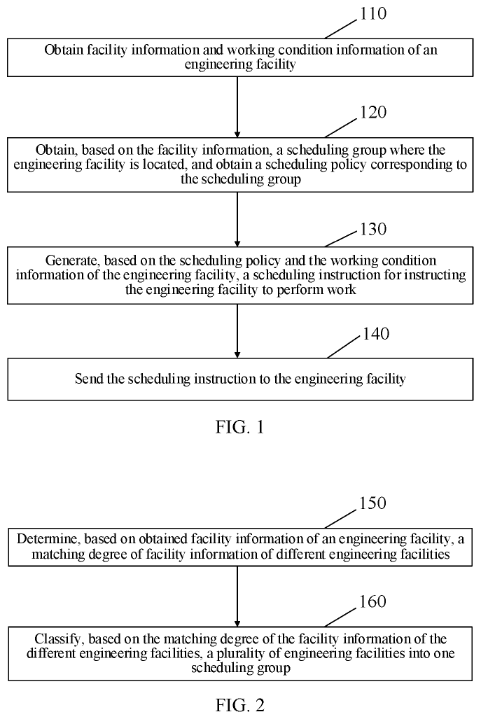

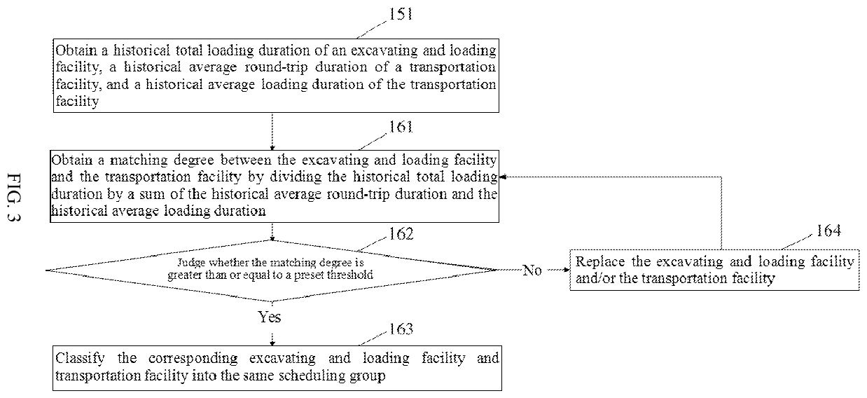

FIG. 2 shows a schematic diagram of steps of an engineering facility scheduling method provided by another embodiment of the present application. In some embodiments, as shown in FIG. 2, the scheduling group where the engineering facility is located is determined by the following steps.

Step 150: Determine, based on the obtained facility information of the engineering facility, a matching degree of facility information of different engineering facilities.

During performing of this step, the scheduling group where the engineering facility is located may be known from the facility information.

Step 160: Classify, based on the matching degree of the facility information of the different engineering facilities, a plurality of engineering facilities into one scheduling group.

During performing of this step, the plurality of engineering facilities in one scheduling group cooperate with each other to complete a whole set of industrial and mining work. During grouping, a plurality of engineering facilities that may cooperate with each other to complete a whole set of industrial and mining work may form one scheduling group. In the process of grouping, whether to classify a plurality of engineering facilities into the same scheduling group is decided based on the matching degree among the engineering facilities, such that the scheduling group is more reasonable, and each engineering facility in the scheduling group may better cooperate with each other to perform work.

FIG. 3 shows a schematic diagram of steps of an engineering facility scheduling method provided by yet another embodiment of the present application. In some embodiments, the engineering facility includes: an excavating and loading facility and a transportation facility. As shown in FIG. 3, step 150 includes the following steps.

Step 151: Obtain a historical total loading duration of the excavating and loading facility, a historical average round-trip duration of the transportation facility, and a historical average loading duration of the transportation facility.

During performing of this step, each of the durations may be recorded in the facility information of the engineering facility. The historical working data of the engineering facility is recorded in the facility information.

Step 160 includes the following steps.

Step 161: Obtain a matching degree between the excavating and loading facility and the transportation facility by dividing the historical total loading duration by a sum of the historical average round-trip duration and the historical average loading duration.

During performing of this step, the matching degree between the excavating and loading facility and the transportation facility is calculated. The matching degree is used for evaluating whether the excavating and loading facility and the transportation facility are suitable to be classified into the same group. The closer the matching degree is to 100%, the more reasonable the grouping of the corresponding excavating and loading facility and transportation facility is.

Step 162: Judge whether the matching degree is greater than or equal to a preset threshold.

If the matching degree is greater than or equal to the preset threshold, step 163 is performed: classify the corresponding excavating and loading facility and transportation facility into the same scheduling group.

During performing of step 163, if the matching degree meets the requirements, it indicates that the excavating and loading facility and the transportation facility are suitable to be classified into the same scheduling group.

If the matching degree is less than the preset threshold, rematching and grouping are performed. Specifically, step 164 may be performed: replace the excavating and loading facility and/or the transportation facility and perform step 161 again.

During performing of step 164, if the matching degree does not meet the requirements, it indicates that the excavating and loading facility and the transportation facility are not suitable to be classified into the same scheduling group, and need to be replaced with other excavating and loading facility or transportation facility. After the replacement, step 161 may be performed again to calculate a matching degree between the replaced excavating and loading facility and the replaced transportation facility, and then whether the matching degree meets the requirements is judged. If the matching degree meets the requirements, grouping is completed. If the matching degree does not meet the requirements, replacement continues to be performed.

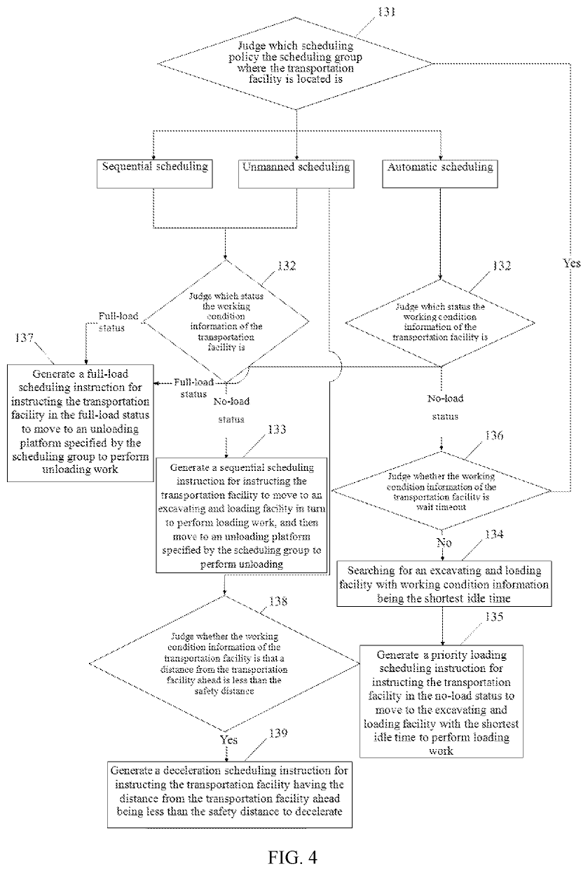

FIG. 4 shows a schematic diagram of steps of an engineering facility scheduling method provided by yet another embodiment of the present application. In some embodiments, the scheduling policy may include sequential scheduling, automatic scheduling, and unmanned scheduling. As shown in FIG. 4, step 130 includes the following steps.

Step 131: Judge which scheduling policy the scheduling group where the transportation facility is located is.

If the scheduling group where the transportation facility is located is sequential scheduling or unmanned scheduling, step 132 is performed: judge which status the working condition information of the transportation facility is. The working condition information may include a no-load status, a full-load status, whether wait timeout occurs, whether a distance from a transportation facility ahead is less than a safety distance, etc.

If the working condition information of the transportation facility is the no-load status, step 133 is performed: generate a sequential scheduling instruction for instructing the transportation facility to move to the excavating and loading facility in turn to perform loading work, and then move to an unloading platform specified by the scheduling group to perform unloading.

During performing of step 133, the excavating and loading facility may be an excavator, and the excavating and loading facility may work at an excavating and loading platform specified by the scheduling group. The transportation facility may be a mining car. The mining car may obtain the sequential scheduling instruction when in the no-load status. The sequential scheduling instruction may instruct the mining car to firstly move to a loading position of the excavator to perform the loading work. Moreover, the sequential scheduling instruction may also be issued to the excavator to instruct the excavator to load the mining car, and then the mining car moves to the unloading platform specified by the scheduling group to perform the unloading work according to the sequential scheduling instruction. After unloading, the mining car is in the no-load status again, and may obtain the sequential scheduling instruction again. When the mining car runs automatically, locations of the mining car and the excavator may be known in real time based on the latitudes and longitudes, such that the mining car may be remotely controlled to run automatically to the excavator based on the real-time latitude and longitude of the mining car.

In some embodiments, one scheduling group may include the following parts: the transportation facility, the excavating and loading facility, the excavating and loading platform where the excavating and loading facility works, and the unloading platform where the transportation facility is unloads. The transportation facility generally moves to the excavating and loading platform for loading when in the no-loaded status, and then moves to the unloading platform for unloading.

In some embodiments, as shown in FIG. 4, step 130 includes the following steps.

If the scheduling group where the transportation facility is located is the automatic scheduling, and the working condition information of the transportation facility is the no-load status, step 136 is performed: judge whether the working condition information of the transportation facility is wait timeout.

If the working condition information of the transportation facility is non-wait timeout, step 134 is performed: search for an excavating and loading facility with working condition information being a shortest idle time.

During performing of step 134, the excavating and loading facility with the shortest idle time is obtained by comparing idle time of a plurality of excavating and loading facilities.

Step 135: Generate a priority loading scheduling instruction for instructing the transportation facility in the no-load status to move to the excavating and loading facility with the shortest idle time to perform loading work.

In step 135, with the priority loading scheduling instruction, the transportation facility in the no-load status may be loaded with goods at the highest speed, thereby improving the overall scheduling efficiency. When the transportation facility runs automatically, the locations of the transportation facility and the excavating and loading facility may be known in real time based on the latitudes and longitudes, such that the transportation facility is remotely controlled to run automatically to the excavating and loading facility with the shortest idle time based on the latitudes and longitudes. Besides, the queuing time for the transportation facility to be loaded may be shortened, the working efficiency of an operator and the facility is improved, and the fuel consumption of the engineering facility is reduced.

In some embodiments, as shown in FIG. 4, step 130 includes the following steps.

If the scheduling group where the transportation facility is located is the automatic scheduling, and if the working condition information of the transportation facility is the no-load status, step 136 is performed: judge whether the working condition information of the transportation facility is wait timeout.

If the transportation facility is wait timeout, it starts again from performing step 131 for generation of the scheduling instruction.

In step 136, whether the transportation facility is wait timeout is used as a generation standard of the scheduling instruction. When the transportation facility is wait timeout, specific conditions of the transportation facility are not clear, and recalculation is needed to obtain a scheduling instruction corresponding to the transportation facility.

In some embodiments, as shown in FIG. 4, step 130 includes the following steps.

If the scheduling group where the transportation facility is located is the sequential scheduling, the automatic scheduling or the unmanned scheduling and the working condition information of the transportation facility is the full-load status, step 137 is performed: generate a full-load scheduling instruction for instructing the transportation facility in the full-load status to move to the unloading platform specified by the scheduling group to perform unloading work.

In step 137, the transportation facility becomes the full-load status after being loaded at the excavating and loading facility. This status may detected by a weighing sensor in the transportation facility. In some specific embodiments, when the transportation facility receives the full-load scheduling instruction within a preset period of time after loading, it indicates that the transportation facility in the full-load status is successfully scheduled, and the transportation facility may move to the unloading platform specified by the scheduling group where the transportation facility is located for unloading.

In some embodiments, as shown in FIG. 4, step 130 includes the following steps.

When the scheduling group where the transportation facility is located is the unmanned scheduling, step 138 is performed: judge whether the working condition information of the transportation facility is that a distance from the transportation facility ahead is less than the safety distance.

If the working condition information of the transportation facility is that the distance from the transportation facility ahead is less than the safety distance, step 139 is performed: generate a deceleration scheduling instruction for instructing the transportation facility having the distance from the transportation facility ahead being less than the safety distance to decelerate.

In step 139, the transportation facility may control the distance from other transportation facilities during unmanned scheduling, thereby ensuring that the transportation facilities may not collide with each other during unmanned scheduling and improving the safety of the scheduling group during the scheduling work. Specifically, the safety distance may be set to be 30 meters or other values. The distance between the transportation facility and the transportation facility ahead may be obtained by obtaining latitudes and longitudes of each transportation facility.

In some embodiments, in a case of special circumstances such as major failures, manual intervention may be carried out to issue a manual instruction to a target engineering facility that needs to be scheduled. The manual instruction may be used for instructing a driver of the engineering facility to operate by himself according to actual situations, so as to deal with emergencies.

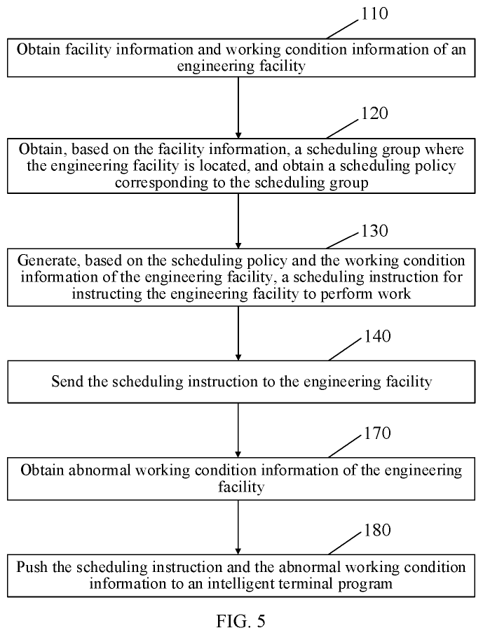

FIG. 5 shows a schematic diagram of steps of an engineering facility scheduling method provided by yet another embodiment of the present application. In some embodiments, as shown in FIG. 5, the engineering facility scheduling method further includes the following steps.

Step 170: Obtain abnormal working condition information of the engineering facility.

In this step, for example, if the engineering facility is in an abnormal maintenance status, whether the engineering facility runs properly may be known in real time after the abnormal working condition information of the engineering facility is obtained.

Step 180: Push the scheduling instruction and the abnormal working condition information to an intelligent terminal program.

During the performing of this step, the intelligent terminal program may be loaded into intelligent terminals for the driver driving the engineering facility and a corresponding administrator. The intelligent terminal program may obtain the scheduling instruction in real time, and then the driver and the administrator may know the scheduling instruction in real time. The driver may operate the engineering facility according to the scheduling instruction, and the scheduling instruction instructs the specific work to be performed by the driver. When the engineering facility is a facility that automatically performs the work, the driver may manually judge whether the engineering facility performs the work according to the scheduling instruction, and adjust the engineering facility according to actual performing situations. In this step, the administrator may know the abnormal working condition information of the unmanned engineering facility through the intelligent terminal. For example, when the unmanned engineering facility is abnormal outage, the abnormal outage may be detected by a speed sensor in the engineering facility; or, whether functions of the engineering facility are normal may also be detected by various fault sensors in the engineering facility, such that the administrator may know the abnormal working condition information in time and perform corresponding maintenance work.

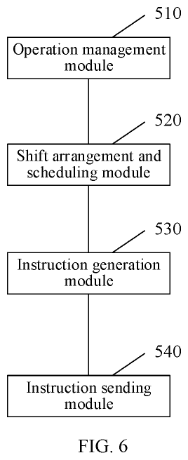

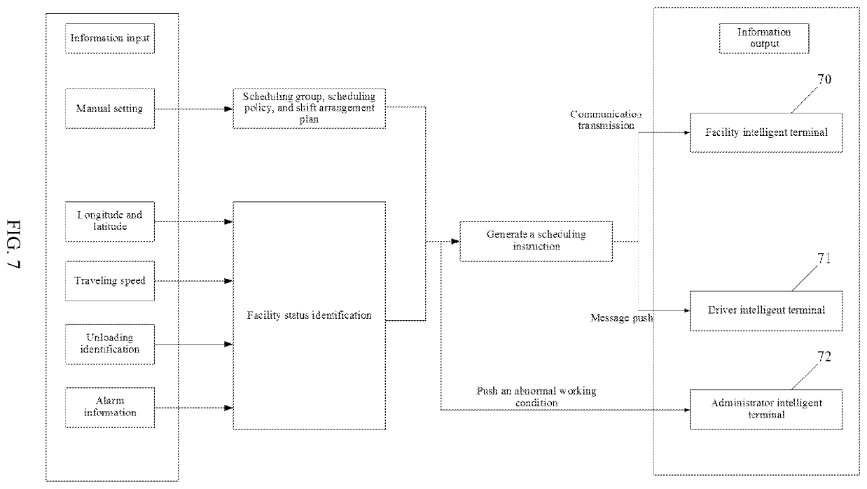

FIG. 6 shows a schematic structural diagram of an engineering facility scheduling system provided by an embodiment of the present application. In some embodiments, the present application further provides an engineering facility scheduling system. As shown in FIG. 6, the system includes: an operation management module 510, a shift arrangement and scheduling module 520, an instruction generation module 530, and an instruction sending module 540. The operation management module 510 is configured to: record facility information and working condition information of an engineering facility and form one scheduling group by a plurality of the engineering facilities. The shift arrangement and scheduling module 520 is electrically connected with the operation management module 510. The shift arrangement and scheduling module 520 is configured to: make a shift arrangement plan and a scheduling policy of the scheduling group. The instruction generation module 530 is electrically connected with the shift arrangement and scheduling module 520. The instruction generation module 530 is configured to: obtain the facility information and the working condition information of the engineering facility, obtain, based on the facility information, the scheduling group where the engineering facility is located, obtain the scheduling policy corresponding to the scheduling group, and generate, based on the scheduling policy and the working condition information of the engineering facility, a scheduling instruction for instructing the engineering facility to perform work. The instruction sending module 540 is electrically connected with the instruction generation module 530. The instruction sending module is configured to: send the scheduling instruction to the engineering facility.

According to this embodiment, during use, the plurality of engineering facilities in one scheduling group cooperate with each other to complete a whole set of industrial and mining work. During grouping, a plurality of engineering facilities that may cooperate with each other to complete a whole set of industrial and mining work may be form one scheduling group. A shift arrangement plan may be shift time used for instructing the scheduling group to perform work, and the engineering facilities in the scheduling group perform work according to the shift time specified in the shift arrangement plan. The scheduling policy is a rule to be followed when the scheduling group is instructed to perform work. Under different scheduling policies, different scheduling instructions may be correspondingly issued to each engineering facility in the scheduling group. Specifically, the facility information may include load data, facility type, latitude and longitude and historical working data of the engineering facility and a scheduling group where the engineering facility is located. A specific location where the engineering facility is located may be known based on the latitude and longitude. The engineering facility may be better scheduled based on the latitude and longitude. The working condition information may include idle status information, waiting time information, no-load status information, and full-load status information of the engineering facility, and information of a distance of the engineering facility from other engineering facilities, and other information of the engineering facility. Moreover, the working condition information may be updated in real time. After the engineering facility performs certain work, the working condition information obtained is the latest working condition information corresponding to real-time data after the engineering facility performs the work. The scheduling group where the engineering facility is located is obtained from the facility information, and then the scheduling policy of the scheduling group is obtained. Different combinations of different scheduling policies and different working condition information may correspond to different scheduling instructions. During performing of this step, when an engineering facility needs to be scheduled, on the basis that different scheduling policies may correspond to different scheduling instructions, and combined with the working condition information of the engineering facility, the scheduling instruction is generated based on the actual working condition information. Moreover, in the process of obtaining the scheduling instruction, the working condition information referred to is the working condition information updated in real time. Finally, the scheduling instruction is sent to the engineering facility for the engineering facility to perform the corresponding work according to the scheduling instruction. Throughout the whole process, manual participation is reduced, and the scheduling instruction may be generated according to the specific scheduling policy and working condition information, thereby increasing the degree of automation of engineering facility scheduling and improving engineering facility scheduling efficiency.

FIG. 7 shows a schematic scheduling flowchart of an engineering facility scheduling method and system provided by an embodiment of the present application. Combined with the above embodiments, the scheduling processing flow may be as shown in FIG. 7. In the scheduling work, the scheduling group, the scheduling policy and the shift arrangement plan may be set manually. The composition of the scheduling group may also be automatically performed by a processor. The processor may decide whether to classify the transportation facility and the excavating and loading facility into the same group based on whether the matching degree reaches the preset threshold; or, whether to classify the transportation facility and the excavating and loading facility into the same group may also be decided by a worker based on the matching degree. The latitude and longitude, traveling speed, unloading identification, and alarm information are facility status identification results and may be completed by various sensors mounted in the engineering facility. The scheduling instruction is obtained based on the facility status identification results in combination with the scheduling group, the scheduling policy and the shift arrangement plan. The scheduling instruction may be sent to a facility intelligent terminal 70 by way of communication transmission to instruct the engineering facility to perform the work corresponding to the scheduling instruction. Message queuing telemetry transport (MQTT) may be adopted for communication transmission. Meanwhile, the scheduling instruction may be sent to a driver intelligent terminal 71 in the form of message push, such that the driver driving the engineering facility may know the scheduling instruction in real time, and operate according to the scheduling instruction or verify whether the work performed by the engineering facility is correct by referring to the scheduling instruction. During facility status identification, if some abnormal working conditions, such as the alarm information, are identified, the abnormal working conditions may be pushed to an administrator intelligent terminal 72, such that the administrator may know the abnormal working conditions of the engineering facility in real time.

The present application further provides an engineering facility. The engineering facility includes: a facility intelligent terminal. The facility intelligent terminal is configured to:
obtain the scheduling instruction in any one of the above embodiments;
switch the engineering facility to an online status and instruct the engineering facility to perform work corresponding to the scheduling instruction, if it is identified that the engineering facility has a working condition information within a preset period of time; and
switch the engineering facility to a rest status or an offline status and instruct the engineering facility not to perform work, if it is identified that the engineering facility has no working condition information within a preset period of time.

In this embodiment, the facility intelligent terminal is used for controlling the engineering facility, and switching the engineering facility to the online status, the rest status or the offline status. The engineering facility may not perform work according to the scheduling instruction when in the rest status or the offline status. Specifically, the preset period of time may be 5 minutes.

In some specific embodiments, the facility intelligent terminal in the engineering facility may be provided with an instruction display module, and the instruction display module may display the scheduling instruction obtained by the engineering facility. If the engineering facility is manned, a driver may drive according to the scheduling instruction displayed on the instruction display module, and the driver may easily find a destination and know the work content.

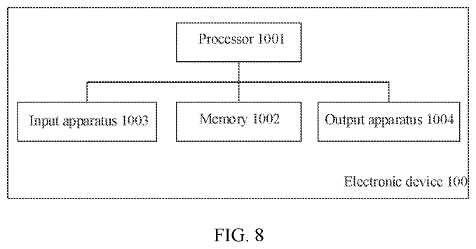

An electronic device according to an embodiment of the present application is described below with reference to FIG. 8. FIG. 8 shows a schematic structural diagram of an electronic device provided by an embodiment of the present application.

As shown in FIG. 8, the electronic device 100 includes one or more processors 1001 and a memory 1002.

The processor 1001 may be a central processing unit (CPU) or other forms of processing units having a data processing capability and/or instruction performing capability, and may control other components in the electronic device 100 to perform desired functions.

The memory 1002 may include one or more computer program products, and the computer program products may include various forms of computer-readable storage media, such as a volatile memory and/or a non-volatile memory. The volatile memory may include a random access memory (RAM) and/or a cache memory, etc. The non-volatile memory may include a read only memory (ROM), a hard disk, a flash memory, etc. One or more computer program instructions may be stored on the computer-readable storage medium, and the processor 1001 may run the program instructions to implement the above-mentioned engineering facility scheduling method according to each embodiment of the present application or other desired functions. Various contents such as error scheduling policies and error scheduling instruction parameters may also be stored in the computer-readable storage medium.

In one example, the electronic device 100 may further include: an input apparatus 1003 and an output apparatus 1004. These components are interconnected via a bus system and/or other forms of connection mechanisms (not shown).

The input apparatus 1003 may include a keyboard, a mouse, a joystick, a touch screen, etc.

The output apparatus 1004 may output various information to the outside, including determined motion data, etc. The output apparatus 1004 may include a display, a communication network and a remote output device connected with the communication network, etc.

Of course, for simplicity, only some of the components, relevant to the present application, in the electronic device 100 are shown in FIG. 8, omitting components such as buses and input/output interfaces. In addition, the electronic device 100 may also include any other appropriate components, depending on the specific application.

In addition to the method and device described above, an embodiment of the present application may also be a computer program product. The computer program product includes computer program instructions which, when run by a processor, cause the processor to perform the steps in the engineering facility scheduling method according to the various embodiments of the present application described in this specification.

Program codes for performing the operations of the embodiments of the present application may be written in any combination of one or more programming languages, including object-oriented programming languages such as Java and C++, and conventional procedural programming languages such as “C” language or similar programming languages. The program codes may be executed completely on a user computing device, partially on a user device, as a separate software package, partially on a user computing device and partially on a remote computing device, or completely on a remote computing device or server.

In addition, an embodiment of the present application may also be a computer-readable storage medium having computer program instructions stored on the computer-readable storage medium. The computer program instructions, when run by a processor, cause the processor to perform the steps in the engineering facility scheduling method according to the various embodiments of the present application described in this specification.

The computer-readable storage medium may adopt any combination of one or more readable media. The readable medium may be a readable signal medium or a readable storage medium. The readable storage medium may include, but is not limited to, an electrical, magnetic, optical, electromagnetic, infrared, or semiconductor system, apparatus, or component, or any combination of the above. More specific examples (a non-exhaustive list) of the readable storage medium include: connection with one or more wires, a portable disk, a hard disk, a random access memory (RAM), a read only memory (ROM), an erasable programmable read-only memory (EPROM or flash memory), an optical fiber, a portable compact disc read-only memory (CD-ROM), an optical storage device, a magnetic storage device, or any suitable combination of the above.

The basic principles of the present application are described above in conjunction with specific embodiments, however, it is to be noted that the features, advantages, effects, etc. mentioned in the present application are merely illustrative and not restrictive, and they are not to be considered as necessary for each embodiment of the present application. In addition, the specific details disclosed above are for the role of example and ease of understanding merely, and not for limitation, and the above details do not limit the present application as having to adopt the above specific details for implementation.

The block diagrams of the components, apparatus, device and system involved in the present application are only illustrative examples and are not intended to require or imply that they must be connected, arranged, or configured in the manner illustrated in the block diagrams. As those skilled in the art will recognize, the components, apparatus, device and system may be connected, arranged and configured in any manner. Words such as “comprise,” “include,” and “have,” are open-ended terms that mean “including, but not limited to” and may be used interchangeably therewith. The terms “or” and “and” as used herein refer to the term “and/or” and are used interchangeably therewith unless the context clearly indicates otherwise. The term “such as” as used herein refers to the phrase “such as, but not limited to” and is used interchangeably therewith.

It is also to be noted that in the apparatus, device and method of the present application, the components or steps may be decomposed and/or recombined. These decompositions and/or recombinations shall be considered as equivalent solutions of the present application.

The above description of the disclosed aspects is provided to enable any person skilled in the art to make or use the present application. Various modifications to these aspects are readily apparent to those skilled in the art, and the general principles defined herein may be applied to other aspects without departing from the scope of the present application. Accordingly, the present application is not intended to be limited to the aspects shown herein, but rather to the widest scope consistent with the principles and novel features applied herein.

The above are merely preferred embodiments of the present application, and are not intended to limit the present application. Any modifications, equivalent replacements, etc. made within the spirit and principles of the present application shall fall within the protection scope of the present application.

1. An engineering facility scheduling method, comprising:
obtaining facility information and working condition information of an engineering facility;
obtaining, based on the facility information, a scheduling group where the engineering facility is located, and obtaining a scheduling policy corresponding to the scheduling group;
generating, based on the scheduling policy and the working condition information of the engineering facility, a scheduling instruction for instructing the engineering facility to perform work; and
sending the scheduling instruction to the engineering facility.

2. The engineering facility scheduling method according to claim 1, wherein the scheduling group where the engineering facility is located is determined by following steps:
determining, based on the obtained facility information of the engineering facility, a matching degree of facility information of different engineering facilities; and
classifying, based on the matching degree of the facility information of the different engineering facilities, a plurality of the engineering facilities into one scheduling group.

3. The engineering facility scheduling method according to claim 2, wherein
the engineering facility comprises: an excavating and loading facility and a transportation facility;
wherein the obtaining the facility information of the engineering facility comprises:
obtaining a historical total loading duration of the excavating and loading facility, a historical average round-trip duration of the transportation facility, and a historical average loading duration of the transportation facility;
wherein the classifying, based on the matching degree of the facility information of the different engineering facilities, the plurality of the engineering facilities into one scheduling group comprises:
obtaining a matching degree between the excavating and loading facility and the transportation facility by dividing the historical total loading duration by a sum of the historical average round-trip duration and the historical average loading duration;
classifying, if the matching degree is greater than or equal to a preset threshold, the corresponding excavating and loading facility and transportation facility into the same scheduling group; and
performing rematching and grouping if the matching degree is less than the preset threshold.

4. The engineering facility scheduling method according to claim 1, wherein the scheduling policy comprises sequential scheduling and unmanned scheduling; and
the generating, based on the scheduling policy and the working condition information of the engineering facility, the scheduling instruction for instructing the engineering facility to perform work comprises:
generating, if the scheduling group where the transportation facility is located is the sequential scheduling or the unmanned scheduling and the working condition information of the transportation facility is a no-load status, a sequential scheduling instruction for instructing the transportation facility to move to the excavating and loading facility in turn to perform loading work, and then move to an unloading platform specified by the scheduling group to perform unloading.

5. The engineering facility scheduling method according to claim 4, wherein the scheduling policy further comprises automatic scheduling; and
the generating, based on the scheduling policy and the working condition information of the engineering facility, the scheduling instruction for instructing the engineering facility to perform work further comprises:
searching for an excavating and loading facility with working condition information being a shortest idle time and generating a priority loading scheduling instruction for instructing the transportation facility in the no-load status to move to the excavating and loading facility with the shortest idle time to perform loading work, if the scheduling group where the transportation facility is located is the automatic scheduling, the working condition information of the transportation facility is the no-load status, and the working condition information of the transportation facility is non-wait timeout.

6. The engineering facility scheduling method according to claim 4, wherein the scheduling policy further comprises automatic scheduling; and
the generating, based on the scheduling policy and the working condition information of the engineering facility, the scheduling instruction for instructing the engineering facility to perform work further comprises:
regenerating a scheduling instruction if the scheduling group where the transportation facility is located is the automatic scheduling, the working condition information of the transportation facility is the no-load status, and the working condition information of the transportation facility is wait timeout.

7. The engineering facility scheduling method according to claim 5, wherein
the generating, based on the scheduling policy and the working condition information of the engineering facility, the scheduling instruction for instructing the engineering facility to perform work further comprises:
generating, if the scheduling group where the transportation facility is located is the sequential scheduling, the automatic scheduling or the unmanned scheduling and the working condition information of the transportation facility is a full-load status, a full-load scheduling instruction for instructing the transportation facility in the full-load status to move to an unloading platform specified by the scheduling group to perform unloading work.

8. The engineering facility scheduling method according to claim 4, wherein the generating, based on the scheduling policy and the working condition information of the engineering facility, the scheduling instruction for instructing the engineering facility to perform work further comprises:
generating, if the scheduling group where the transportation facility is located is the unmanned scheduling, and the working condition information of the transportation facility is that a distance from a transportation facility ahead is less than a safety distance, a deceleration scheduling instruction for instructing the transportation facility having the distance from the transportation facility ahead being less than the safety distance to decelerate.

9. The engineering facility scheduling method according to claim 1, wherein the facility information comprises at least one of load data, facility type, latitude and longitude and historical working data of the engineering facility, and a scheduling group where the engineering facility is located.

10. The engineering facility scheduling method according to claim 1, wherein the working condition information comprises at least one of idle status information of the engineering facility, waiting time information of the engineering facility, no-load status information of the engineering facility, full-load status information of the engineering facility, and information of a distance of the engineering facility from other engineering facilities.

11. An engineering facility scheduling system, comprising:
an operation management module configured to: record facility information and working condition information of an engineering facility and form one scheduling group by a plurality of engineering facilities;
a shift arrangement and scheduling module electrically connected with the operation management module and configured to: make a shift arrangement plan and a scheduling policy of the scheduling group;
an instruction generation module electrically connected with the shift arrangement and scheduling module and configured to: obtain the facility information and the working condition information of the engineering facility, obtain, based on the facility information, the scheduling group where the engineering facility is located, obtain the scheduling policy corresponding to the scheduling group, and generate, based on the scheduling policy and the working condition information of the engineering facility, a scheduling instruction for instructing the engineering facility to perform work; and
an instruction sending module electrically connected with the instruction generation module and configured to: send the scheduling instruction to the engineering facility.

12. An engineering facility, comprising:
a facility intelligent terminal configured to:
obtain the scheduling instruction according to claim 1;
switch the engineering facility to an online status and instruct the engineering facility to perform work corresponding to the scheduling instruction, if it is identified that the engineering facility has the working condition information within a preset period of time; and
switch the engineering facility to a rest status or an offline status and instruct the engineering facility not to perform work, if it is identified that the engineering facility has no working condition information within the preset period of time.

13. An electronic device, comprising a memory, a processor, and a computer program that is stored on the memory and capable of running on the processor, the processor, when executing the program, implementing steps of the engineering facility scheduling method according to claim 1.

14. A computer-readable storage medium, having a computer program stored on the computer-readable storage medium, the computer program being used for performing steps of the engineering facility scheduling method according to claim 1.

15. The engineering facility scheduling method according to claim 2, wherein the scheduling policy comprises sequential scheduling and unmanned scheduling; and
the generating, based on the scheduling policy and the working condition information of the engineering facility, the scheduling instruction for instructing the engineering facility to perform work comprises:
generating, if the scheduling group where the transportation facility is located is the sequential scheduling or the unmanned scheduling and the working condition information of the transportation facility is a no-load status, a sequential scheduling instruction for instructing the transportation facility to move to the excavating and loading facility in turn to perform loading work, and then move to an unloading platform specified by the scheduling group to perform unloading.

16. The engineering facility scheduling method according to claim 15, wherein the scheduling policy further comprises automatic scheduling; and
the generating, based on the scheduling policy and the working condition information of the engineering facility, the scheduling instruction for instructing the engineering facility to perform work further comprises:
searching for an excavating and loading facility with working condition information being a shortest idle time and generating a priority loading scheduling instruction for instructing the transportation facility in the no-load status to move to the excavating and loading facility with the shortest idle time to perform loading work, if the scheduling group where the transportation facility is located is the automatic scheduling, the working condition information of the transportation facility is the no-load status, and the working condition information of the transportation facility is non-wait timeout.

17. The engineering facility scheduling method according to claim 15, wherein the scheduling policy further comprises automatic scheduling; and
the generating, based on the scheduling policy and the working condition information of the engineering facility, the scheduling instruction for instructing the engineering facility to perform work further comprises:
regenerating a scheduling instruction if the scheduling group where the transportation facility is located is the automatic scheduling, the working condition information of the transportation facility is the no-load status, and the working condition information of the transportation facility is wait timeout.

18. The engineering facility scheduling method according to claim 3, wherein the scheduling policy comprises sequential scheduling and unmanned scheduling; and
the generating, based on the scheduling policy and the working condition information of the engineering facility, the scheduling instruction for instructing the engineering facility to perform work comprises:
generating, if the scheduling group where the transportation facility is located is the sequential scheduling or the unmanned scheduling and the working condition information of the transportation facility is a no-load status, a sequential scheduling instruction for instructing the transportation facility to move to the excavating and loading facility in turn to perform loading work, and then move to an unloading platform specified by the scheduling group to perform unloading.

19. The engineering facility scheduling method according to claim 18, wherein the scheduling policy further comprises automatic scheduling; and
the generating, based on the scheduling policy and the working condition information of the engineering facility, the scheduling instruction for instructing the engineering facility to perform work further comprises:
searching for an excavating and loading facility with working condition information being a shortest idle time and generating a priority loading scheduling instruction for instructing the transportation facility in the no-load status to move to the excavating and loading facility with the shortest idle time to perform loading work, if the scheduling group where the transportation facility is located is the automatic scheduling, the working condition information of the transportation facility is the no-load status, and the working condition information of the transportation facility is non-wait timeout.

20. The engineering facility scheduling method according to claim 18, wherein the scheduling policy further comprises automatic scheduling; and
the generating, based on the scheduling policy and the working condition information of the engineering facility, the scheduling instruction for instructing the engineering facility to perform work further comprises:
regenerating a scheduling instruction if the scheduling group where the transportation facility is located is the automatic scheduling, the working condition information of the transportation facility is the no-load status, and the working condition information of the transportation facility is wait timeout.
